(19) United States
(12) Patent Application Publication
(10) Pub. No.: US 2006/0207784 A1
(43) Pub. Date: Sep. 21, 2006

(54) Signal transmission cable

(75) Inventor: Che-Chia Chang, Taipei Hsien (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Comax Technology Inc.

(21) Appl. No.: 11/255,970

(22) Filed: Oct. 24, 2005

(30) Foreign Application Priority Data
Mar. 15, 2005 (TW) 94107950

(51) Int. Cl. H02G 15/08

(52) U.S. Cl. 174/88 C

(57) ABSTRACT

A signal transmission cable comprises a plurality of transmission channels adhesively covered with a first conductive shielding unit respectively . Each transmission channel comprises a pair of signal lines t, which each has a conductor electrically connected to each of the terminals of an electrical connector respectively, and an insulation medium covered and insulating each conductor therein. Then, all the first conductive shielding and the insulation medium of naked signal lines adhesively covered by a second conductive shielding unit for shielding guiding electromagnetic noise to the ground completely. Thus, all voltage noise outside the insulation medium of each section of the transmission channels are capable of being gathered and guided outward through the grounding area with equally short distances.

### BACKGROUND OF THE INVENTION

1. Field of the Invention

The present invention is related to a signal transmission cable and particularly to a flat type of high frequency signal transmission cable with excellent resistance against electromagnetic interference.

2. Brief description of Related Art

Due to the electric current is transmitted through a transmission cable having different potentials between the signal emit end and the signal receiving end. A noise voltage will be resulted from potential difference between the two ends of the transmission cable that it tunnels through out the insulation layer of the signal line of the transmission cable to bring interference of mutual electromagnetic inductance with the signal of the peripheral circuit. In this condition, the quality of transmitted signal of the integral circuit is affected and it is called EMI (Electromagnetic interference). Hence, how to remove EMI is a critical challenge for maintaining quality of signal transmission.

Referring to FIG. 1, traditionally, the manufacturers often to peel off a small section of insulation layer A1 in surface of the signal cable A that connected with a circuit unit B, so as to the conductive layer A3 of the signal line A2 can stretch out the signal cable A. Then, the conductive layer A3 is locked at a preset grounding chassis D after being tied tightly with a conductive terminal C to allow the noise voltage being guided to the ground area via the conductive terminal C for expelling the magnetic convergent effect therein. However, the deficiency of this prior art for removing EMI is only expelled the noise voltage via the area of conductive terminal C directly, thus being still capable of tunneling the insulation layer at the middle section of signal cable far to the conductive terminal.

In order to solve the preceding problem, Taiwanese Patent Application No. 90224108 discloses a plurality of grounding areas to divide equally at the insulation layer of the transmission cable, thereby multi-point connection with the preset grounding area to remove the noise voltage. However, it will require much time and cost for manufacturing multi-point grounding section in cable, and it is necessary to provide additional clamping elements for securing each grounding section. Furthermore, each clamping element have to be made with great precision, otherwise the problem of EMI resulting from noise voltage is still live.

### SUMMARY OF THE INVENTION

An object of the present invention is to provide a signal transmission cable for being capable of decreasing voltage noise and can be fabricated effectively.

Another object of the present invention is to provide a signal transmission cable with high competitiveness, high reliability and low fabrication cost.

In order to achieve the preceding objects, the signal transmission cable according to the present invention comprises a plurality of transmission channels adhesively covered with a first shielding unit respectively thereof. Each transmission channel comprises a plurality of conductor electrically connected to each of the terminals of an electrical connector respectively, and an insulation medium covered and insulated each conductor therein. Then, all the first conductive shielding and the insulation medium of signal lines adhesively covered by a second conductive shielding unit for guiding electromagnetic noise to the ground completely.

Wherein, Each of the transmission channels further comprises a pair of independent signal lines respectively coupled to each two signal terminals of an electrical connector, to offer current in circuit equipment a transmission path and having a insulation medium between the signal lines and the first shielding unit.

Wherein, the first shielding unit electrically contacts with at least a naked grounding wire.

Wherein, the first shielding unit is an aluminum Mylar foil.

Wherein, the second shielding unit is a metal non-woven fabric to adhesively cover the first shielding unit of each transmission channel.

Wherein, the grounding area is a metal casing to electrically contact with the second shielding unit for guiding the electromagnetic noise to the ground completely.

### BRIEF DESCRIPTION OF THE DRAWINGS

The present invention can be more fully understood by reference to the following description and accompanying drawings, in which:

FIG. 1 shows a schematic view of a conventional signal transmission cable;

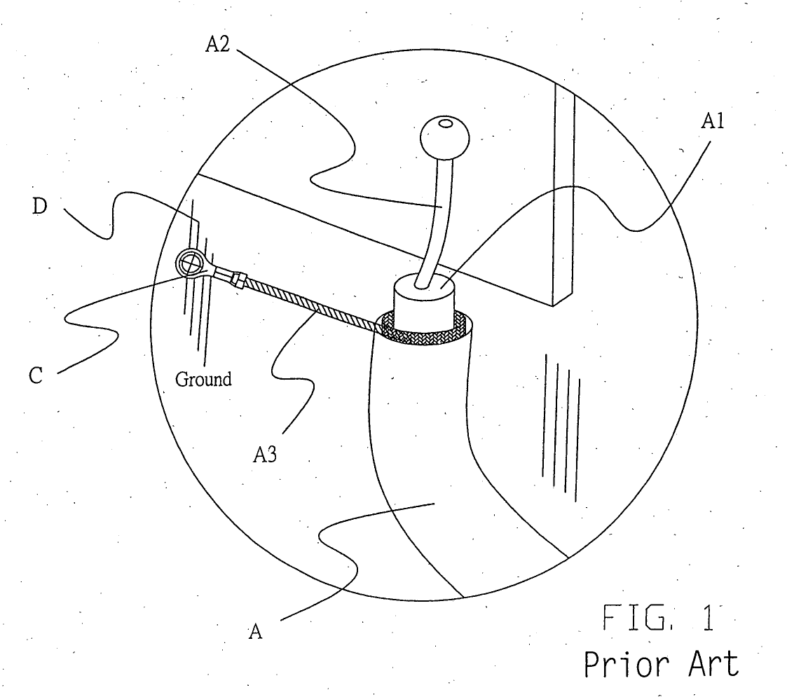

FIG. 2 shows a exploded view of the signal transmission cable according to the first embodiment of the present invention;

FIG. 3 shows a sectional view of the signal transmission cable according to the first embodiment of the present invention;

FIG. 4 shows a schematic view of the signal transmission cable in use according to the first embodiment of the present invention;

FIG. 5 shows a sectional view of the signal transmission cable according to the second embodiment of the present invention;

FIG. 6 shows a plan view of the signal transmission cable in use according to the second embodiment of the present invention;

FIG. 7 shows a plan view of the signal transmission cable according to the third embodiment of the present invention;

FIG. 8 is a plan view illustrating the signal transmission cable shown in FIG. 7 fixedly joined to the signal transmission end in an electrical connector according to the third embodiment of the present invention; and

FIG. 9 shows a sectional view of the signal transmission cable being embodied to a socket according to the third embodiment of the present invention.

### DETAILED DESCRIPTION OF THE INVENTION

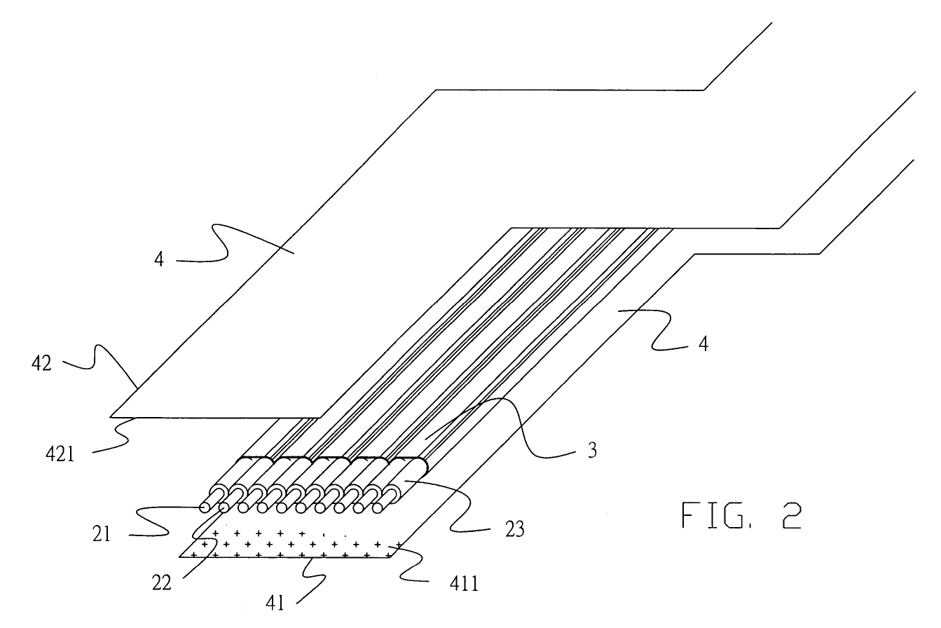

Referring to FIG. 2, a preferred embodiment of a signal transmission cable according to the present invention is illustrated. The signal transmission cable 1 shown in FIG. 2 includes a plurality of transmission channels 2, a first shielding unit 3, a second shielding unit 4 and at least a grounding end 5.

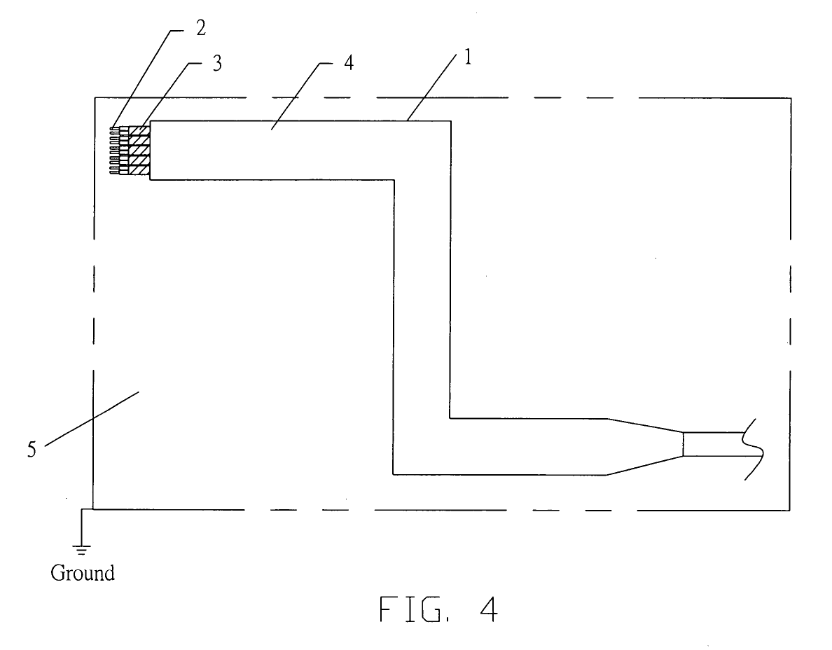

Referring to FIG. 4, each of the transmission channels 2 is formed by a pair of independent signal lines 21, 22 to perform signal transmission. The first shielding unit 3 covers the pair of signal lines 21, 22 to offer a transmission loop between two circuit equipment. Two signal lines forming a transmission pair and transmitting differential Non-Return to Zero encoding signals. An insulation medium 23 is covered between the signal lines 21, 22 and the first shielding unit 3 to isolate the transmission signal from the voltage noise. The signal lines 21, 22 have a conductive core 24 respectively to connect with each of the terminals of an electrical connector (not shown) based on different requirements of circuit design. Each conductive core of the transmission channels is made of a conductive medium. The first shielding unit 3 provides a conductive side with aluminum Mylar foil or other flexible metal foil and another side with an insulation gluey layer 31 corresponding to a non-conductive layer of the transmission channels for adhering the insulation medium 23 of signal lines. For instance, the insulation gluey layer 31 can be thermoplastic material paved on the non-conductive side of the aluminum Mylar foil to form a self-glue tape. Then, the signal lines 21, 22 are bound tightly with the shielding unit 3 by way of the insulation gluey layer 31 being the inner side thereof and spirally coiling or wrapping the signal lines 21, 22. Next to heat the thermoplastic material to melt immediately until being blended with the insulation 23 after completing the step of coiling or wrapping.

The second shielding unit 4 includes two metal non-woven fabrics 41, 42. One side of metal non-woven fabrics has a conductive glue layer 411, 421 forming two conductive gluey tapes oppositely to adhesively wrapping the shielding unit 3 of the transmission channels 2. Then all the transmission channels 2 will be covered adhesively between two metal non-woven fabrics 41, 42.

The grounding area 5 can be a metal casing to electrically contact with one of the metal non-woven fabrics 41, 42, thereby all the electromagnetic noise distributed on the second shielding unit 3 can be guided to the grounding area 5.

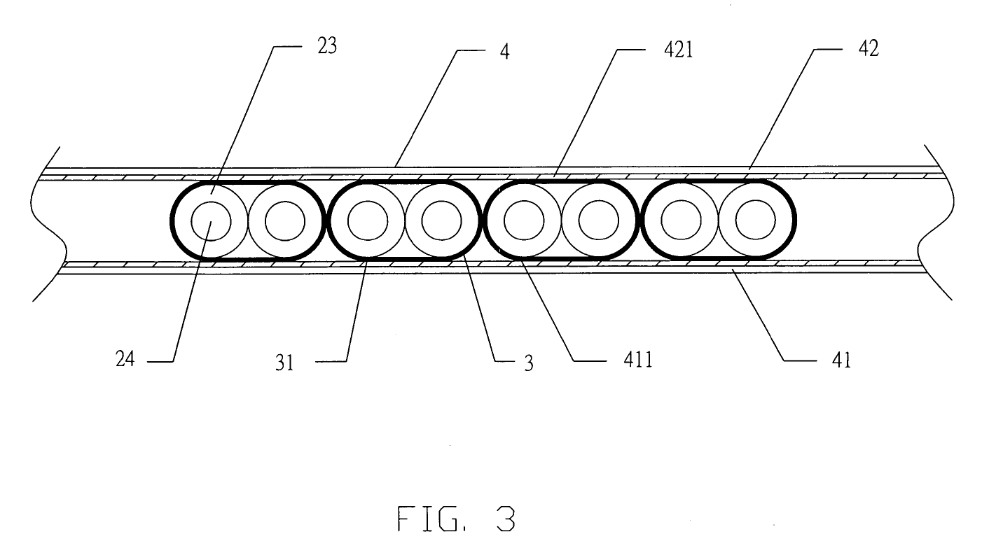

Referring to FIGS. 2 and 3, each pair of signal lines 21, 22 is coiled with the first shielding unit 3 to form the transmission channels 2 and the conductive core 24 of the signal lines 21, 22 is joined to the signal terminals of the electrical connector respectively. Next, all the first shielding unit and insulation medium 23 outside of the transmission channels 2 are sequentially adhesively covered between a conductive gluey layer 411 of the metal non-woven fabric 41 and the conductive gluey layer 412 of the metal non-woven fabric 42 oppositely that forming a flat type of signal transmission cable 1 electrically connected and fixed to the grounding area 5 directly with the second shielding unit 4, so as to achieve completely electrically contacting shielding as shown in FIG. 4. In this way, all voltage noise outside the insulation medium 23 of each section of transmission channels 2 in the signal cable 1 can be guided outward through the grounding area 5 with an equally short distance respectively without setting extra multi-point connection equally thereof. It is capable of decreasing material cost and enhancing efficiency of manufacturing process, especially, in the light of high frequency signal transmission field.

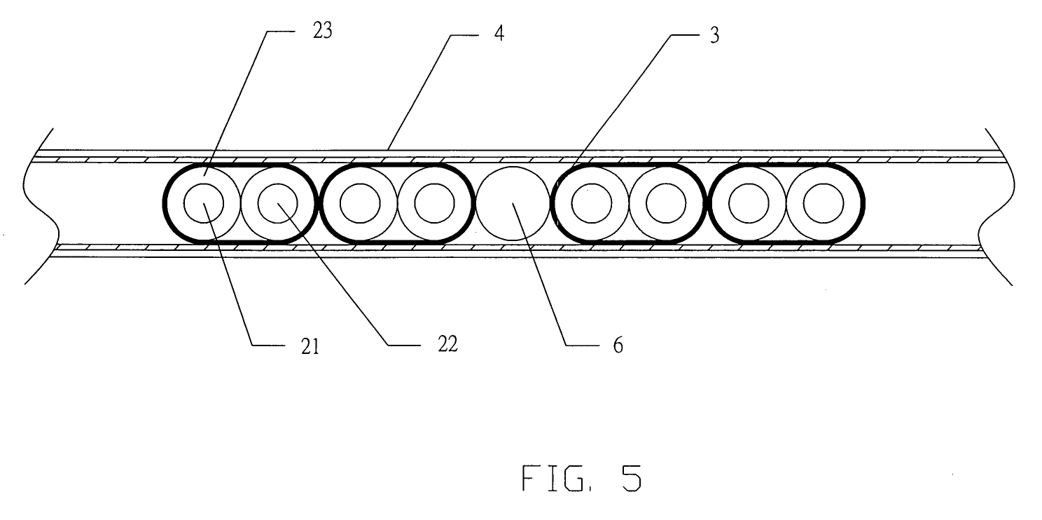

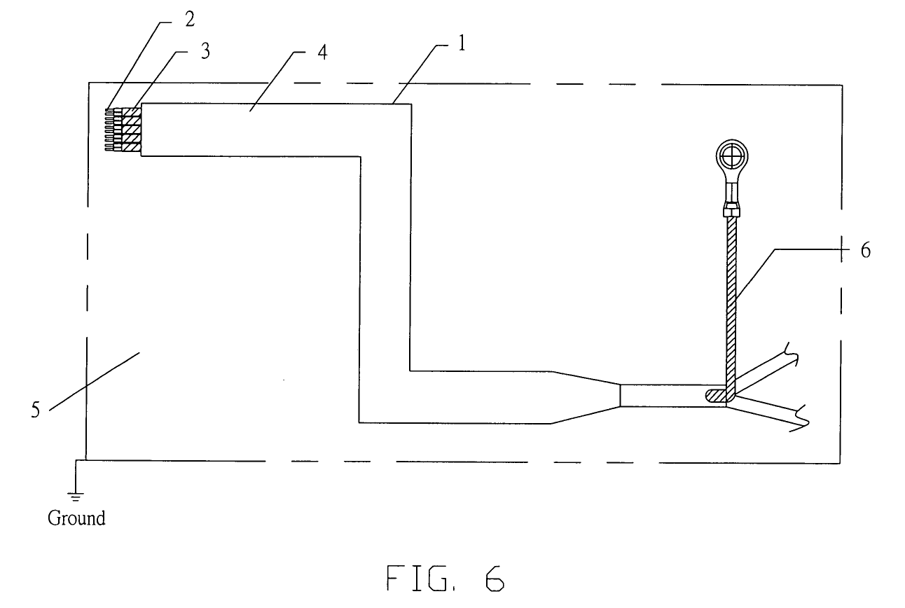

Referring to FIGS. 5 and 6, another embodiment is illustrated. It can be seen that the signal cable includes a plurality of transmission channels 2, a first shielding unit 3, a second shielding unit 4, at least a grounding area and at least a naked grounding wire 6.

Wherein, each of the transmission channels 2 further includes a pair of independent signal lines 21, 22 to perform signal transmission. The pair of signal lines 21, 22 is adhesively covered with the first shielding unit 3 and an insulation medium 23 is disposed between the pair of the signal lines 21, 22 and the first shielding unit 3. The naked grounding wire 6 electrically contacts with first shielding unit 3 outside the transmission channels 2 and the second shielding unit 4 is covered to adhere the first shielding unit 3 and the grounding wire 6 respectively. Further, the grounding area 5 contacts with the second shielding unit 4 such that the electromagnetic noises both of the transmission channels 2 and the grounding wire 6 can be guided to the ground. The grounding wire 6 is naked so that it is capable of enhancing to the electrical effect of grounding.

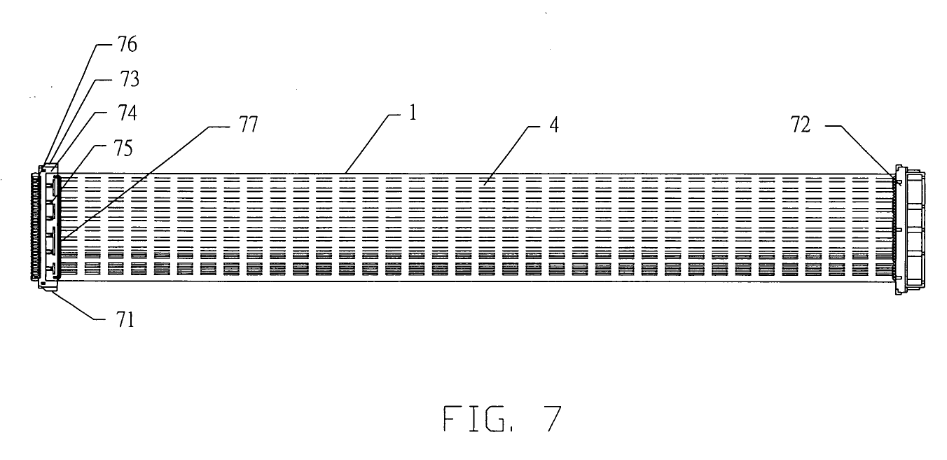

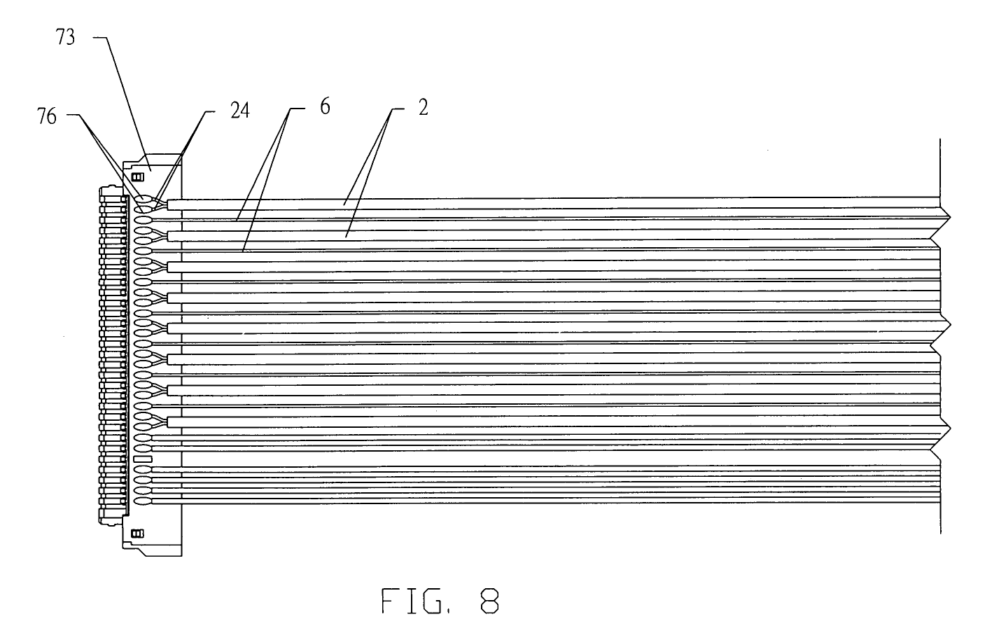

Referring to FIG. 7, an electrical connector being adapted to the signal cable 1 of the present invention is illustrated. It can be seen that both ends of the signal cable 1 is electrically connected to an electrical connector 71 and a second electrical connector 72 for forming an input signal port and an output signal port. The electrical connector 71 includes an insulation body 73 for dividing and receiving a plurality of signal terminals 76 and a metal housing 74 (see FIG. 8) for covering and locating the insulation body 73. Each of the transmission channels 2 is covered with the first shielding unit 3. A pair of the conductive core 24 in the signal lines 21, 22 are electrically connected to each signal terminal 76 of the insulation body respectively and shielded and located the insulation body 73 with the metal housing 74 before being covered with the second shielding unit 4, so as to insulate the conductive core 24 and the second shielding unit 4. Thus, the electromagnetic noises in contact between the first shielding unit 3 and the second shielding unit 4 are guided to the grounding area 5 completely.

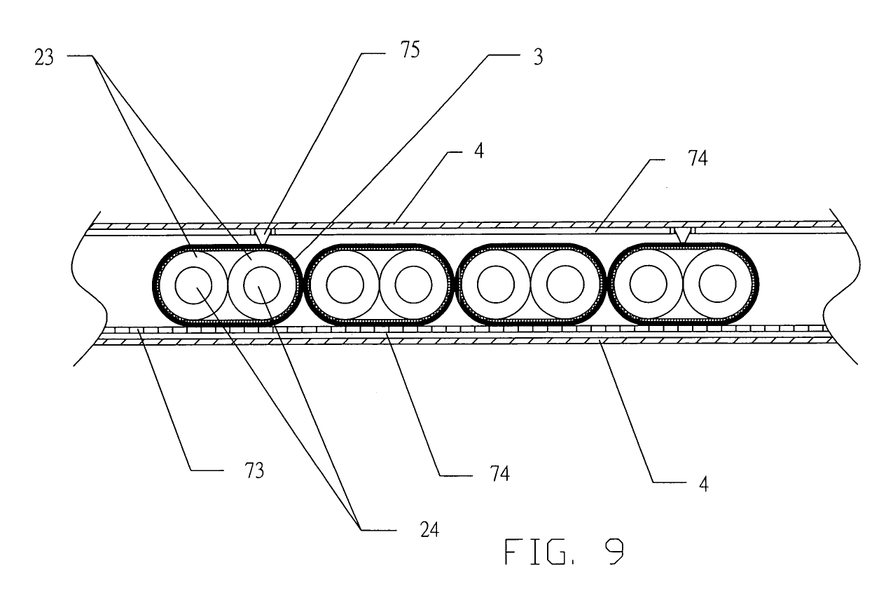

Referring to FIG. 7 and 9, the metal housing 74 provides a plurality of metal pressing parts 75 corresponding to the grounding end of the electrical connector for enhancing conductive effect of the grounding area while the metal housing 74 covering and locating the insulation member 73. Further, hardening bond 77 is used to reinforce locating after the conductive medium 24 of the signal lines 21, 22 being electrically connected to the signal terminal 76 for increasing resistance from being pulled out.

It is appreciated that the present invention offers a better and feasible signal transmission cable to overcome deficiency resulting from fabricating the conventional transmission cable and isolating electromagnetic noises. Thus, all voltage noises outside the insulation medium of each section of the signal lines can be gathered and guided outward through the grounding area with equally short distances arrangement of the present invention. These are unable to reach with the prior art.

While the invention has been described with referencing to preferred embodiments thereof, it is to be understood that modifications or variations may be easily made without departing from the spirit of this invention, which is defined by the appended claims.

1-22. (canceled)

23. A signal transmission cable comprising:
a) a plurality of transmission channels, each of the plurality of transmission channels having:
i) a pair of conductors being independent; and
ii) an insulation medium covering and insulating each of the pair of conductors;
b) two electrical connectors located on opposing ends thereof, each of the two electrical connectors having a plurality of pair of signal terminals, one of the plurality of pair of signal terminals is electrically connected to each pair of conductors of the plurality of transmission channels;
c) a first shielding unit covering the insulation medium of each of the plurality of transmission channels;
d) a second shielding unit covering the first shielding unit and the insulation medium of each of the plurality of transmission channels; and
e) a ground receiving electromagnetic noise distributed on the first shielding unit and the second shielding unit.

24. The signal transmission cable according to claim 23, wherein each of the pair of conductors is an independent signal line.

25. The signal transmission cable according to claim 23, wherein the ground includes at least one naked grounding wire, the first shielding unit is electrically connected to the at least one naked grounding wire.

26. The signal transmission cable according to claim 23, wherein each of the pair of conductors of each of the plurality of transmission channels is made of a conductive medium.

27. The signal transmission cable according to claim 26, further comprising a hardening bond reinforcing connections between the conductive medium and the plurality of pair of signal terminals.

28. The signal transmission cable according to claim 23, wherein the first shielding unit includes an aluminum Mylar foil.

29. The signal transmission cable according to claim 23, wherein the first shielding unit has a conductive side located on a first side thereof and an insulation gluey layer located on a second side thereof, the insulation gluey layer is connected to the insulation medium of each of the plurality of transmission channels.

30. The signal transmission cable according to claim 23, wherein the second shielding unit has a metal non-woven fabric having a conductive gluey layer connecting the second shielding unit to the first shielding unit and the insulation medium of each of the plurality of transmission channels.

31. The signal transmission cable according to claim 23, wherein the second shielding unit has two metal non-woven fabrics, each of the two metal non-woven fabrics having a conductive gluey layer connecting the second shielding unit to the first shielding unit and the insulation medium of each of the plurality of transmission channels.

32. The signal transmission cable according to claim 23, wherein each of the two electrical connectors has a metal housing isolating the second shielding unit and each pair of conductors.

33. The signal transmission cable according to claim 32, wherein the metal housing of each of the two electrical connectors has a plurality of metal pressing parts connected to a grounding end thereof.

34. The signal transmission cable according to claim 23, wherein each of the two electrical connectors has:
a) an insulation body, the plurality of pair of signal terminals are located in the insulation body; and
b) a metal housing covering the insulation body and isolating the second shielding unit and each of the pair of conductors of each of the plurality of transmission channels, each of the pair of conductors of each of the plurality of transmission channels is made of a conductive medium.

35. The signal transmission cable according to claim 34, wherein each of the pair of conductors is an independent signal line.

36. The signal transmission cable according to claim 34, wherein the ground includes at least one naked grounding wire, the first shielding unit is electrically connected to the at least one naked grounding wire.

37. The signal transmission cable according to claim 34, wherein the first shielding unit has a conductive side located on a first side thereof and an insulation gluey layer located on a second side thereof, the insulation gluey layer is connected to the insulation medium of each of the plurality of transmission channels.

38. The signal transmission cable according to claim 34, wherein the second shielding unit has a metal non-woven fabric having a conductive gluey layer.

39. The signal transmission cable according to claim 34, wherein the second shielding unit has two metal non-woven fabrics, each of the two metal non-woven fabrics having a conductive gluey layer.

40. The signal transmission cable according to claim 34, wherein the ground is the metal housing of each of the two electrical connectors electrically connected to the second shielding unit.

41. The signal transmission cable according to claim 34, further comprising a hardening bond reinforcing connections between the conductive medium and the plurality of pair of signal terminals.

42. The signal transmission cable according to claim 34, wherein the first shielding unit includes an aluminum Mylar foil.

43. The signal transmission cable according to claim 34, wherein the metal housing of each of the two electrical connectors has a plurality of metal pressing parts connected to a grounding end thereof.
